(19) United States
(12) Patent Application Publication
(10) Pub. No.: US 2012/0307156 A1
(43) Pub. Date: Dec. 6, 2012

(54) ELECTRONIC APPARATUS AND IMAGE PROCESSING METHOD

(76) Inventors: TAKAYA MATSUNO, Ome-shi (JP); HIROFUMI MORI, Fuchu-shi (JP); MASAMI MORIMOTO, Fuchu-shi (JP); SHINGO SUZUKI, Akishima-shi (JP)

(21) Appl. No.: 13/366,029

(22) Filed: Feb. 3, 2012

(30) Foreign Application Priority Data
May 31, 2011 (JP) 2011-122671

(51) Int. Cl. H04N 9/74

(52) U.S. Cl. 348/597; 348/E09.055

(57) ABSTRACT

According to one embodiment, an electronic apparatus includes a motion search module, a flicker reduction module and a display controller. The motion search module determines first vectors including motion vectors corresponding to pixel blocks in a target frame in video data, and determines pixels in a previous frame by using the first vectors, the pixels corresponding to pixels in the target frame. The flicker reduction module reduces flicker by blending a first pixel in the target frame and a second pixel in the previous frame. The display controller controls displaying the target frame including the blended pixel.

### CROSS-REFERENCE TO RELATED APPLICATIONS

This application is based upon and claims the benefit of priority from prior Japanese Patent Application No. 2011-122671, filed May 31, 2011, the entire contents of which are incorporated herein by reference.

### FIELD

Embodiments described herein relate generally to an electronic apparatus which plays back video data, and an image processing method which is applied to the apparatus.

### BACKGROUND

When video data is played back, flicker occurs, in some cases, on a video which is displayed on a screen. Flicker is a temporal fluctuation (noise), which occurs when a video is played back. In order to reduce the flicker, for example, use is made of a method of blending pixel values by using a pixel in a frame which is a target of processing, and a pixel at the same position in an immediately preceding frame. Since the variation of the pixel value is decreased between the frames by this blending, it becomes possible to reduce flicker occurring when a video is played back.

When the above-described blending is applied to an area (still area) in which a temporal variation is small and to an area (non-still area) in which the variation is large, flicker in the still area can be reduced, but it is possible that an image in the non-still area blurs in appearance. Specifically, when the blending is applied to pixels included in the non-still area, it is possible that a variation of pixel values between frames, which is not flicker, is altered to become smaller. Taking this into account, there has been proposed a method in which a still area in a frame is detected, and blending is applied to only pixels included in the detected still area.

However, in the method of applying blending to only the pixels included in the still area, it is difficult to reduce flicker occurring in the non-still area including a moving object.

In addition, when a pixel in the processing-target frame is a pixel included in a moving object, it is possible that this pixel does not correspond to a pixel at the same position in the immediately preceding frame. In other words, it is possible that the position of the pixel included in the moving object is moved between the frames. Thus, in the method of blending pixel values by using a pixel in a processing-target frame and a pixel at the same position in the immediately preceding frame, it is possible that the pixels which do not correspond are blended, and the user may have unnaturalness of a displayed image.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an example of the external appearance of an electronic apparatus according to an embodiment.

FIG. 2 is an exemplary block diagram illustrating an example of the structure of the electronic apparatus of the embodiment.

FIG. 3 is an exemplary block diagram illustrating an example of the structure of a video playback program which is executed by the electronic apparatus of the embodiment.

FIG. 4 is an exemplary conceptual view for explaining an example of a search for a motion between image frames.

FIG. 5 is an exemplary conceptual view for explaining an example of a motion between frames, which is searched by the electronic apparatus of the embodiment.

FIG. 6 is an exemplary conceptual view for explaining another example of a motion between frames, which is searched by the electronic apparatus of the embodiment.

FIG. 7 is an exemplary conceptual view for explaining still another example of a motion between frames, which is searched by the electronic apparatus of the embodiment.

FIG. 8 is an exemplary flowchart illustrating an example of the procedure of a video playback process which is executed by the electronic apparatus of the embodiment.

FIG. 9 is an exemplary flowchart illustrating an example of the procedure of a motion vector selection process which is executed by the electronic apparatus of the embodiment.

FIG. 10 is an exemplary flowchart illustrating an example of the procedure of a flicker reduction process which is executed by the electronic apparatus of the embodiment.

### DETAILED DESCRIPTION

Various embodiments will be described hereinafter with reference to the accompanying drawings.

In general, according to one embodiment, an electronic apparatus includes a motion search module, a flicker reduction module and a display controller. The motion search module determines first vectors including a plurality of motion vectors corresponding to a plurality of pixel blocks in a target frame in video data, and determines a plurality of pixels in a previous frame by using the determined first vectors, the previous frame immediately preceding the target frame, the plurality of pixels corresponding to a plurality of pixels in the target frame. The flicker reduction module reduces flicker occurring when the target frame is played back, by blending a first pixel in the target frame and a second pixel in the previous frame, the second pixel corresponding to the first pixel. The display controller controls displaying the target frame including the blended pixel on a screen.

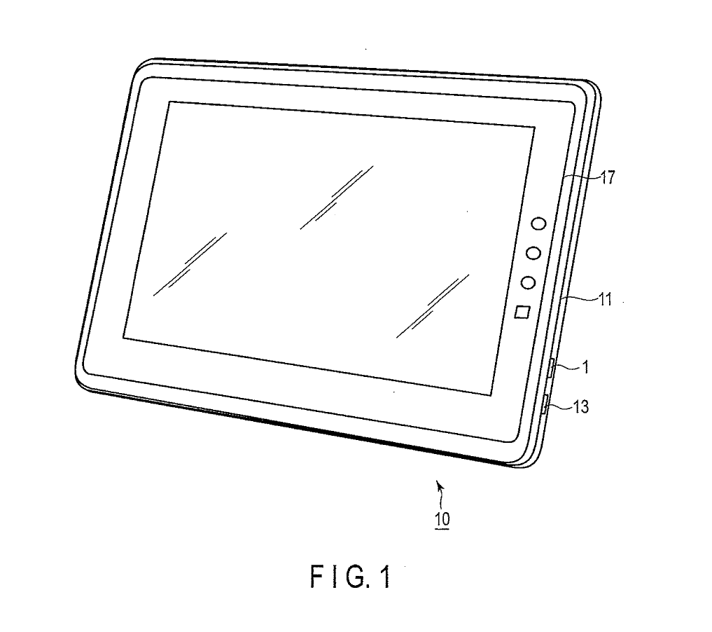

FIG. 1 is a perspective view illustrating the external appearance of an electronic apparatus according to an embodiment. This electronic apparatus is realized, for example, as a tablet-type personal computer (PC) 10. In addition, the electronic apparatus may be realized as a smartphone, a PDA, a notebook-type PC, a television (TV) receiver, etc. As shown in FIG. 1, the computer 10 includes a computer main body 11 and a touch-screen display 17.

The computer main body 11 has a thin box-shaped housing. A liquid crystal display (LCD) 17A and a touch panel 17B are built in the touch-screen display 17. The touch panel 17B is provided so as to cover the screen of the LCD 17A. The touch-screen display 17 is attached to the computer main body 11 in such a manner that the touch-screen display 17 is laid over the top surface of the computer main body 11.

A power button for powering on/off the computer 10, a volume control button, a memory card slot, etc. are disposed on an upper side surface of the computer main body 11. A speaker, etc. are disposed on a lower side surface of the computer main body 11. A right side surface of the computer main body 11 is provided with a USB connector 13 for connection to a USB cable or a USB device of, e.g. the universal serial bus (USB) 2.0 standard, and an external display connection terminal 1 supporting the high-definition multimedia interface (HDMI) standard. This external display connection terminal 1 is used in order to output a digital video signal to an external display.

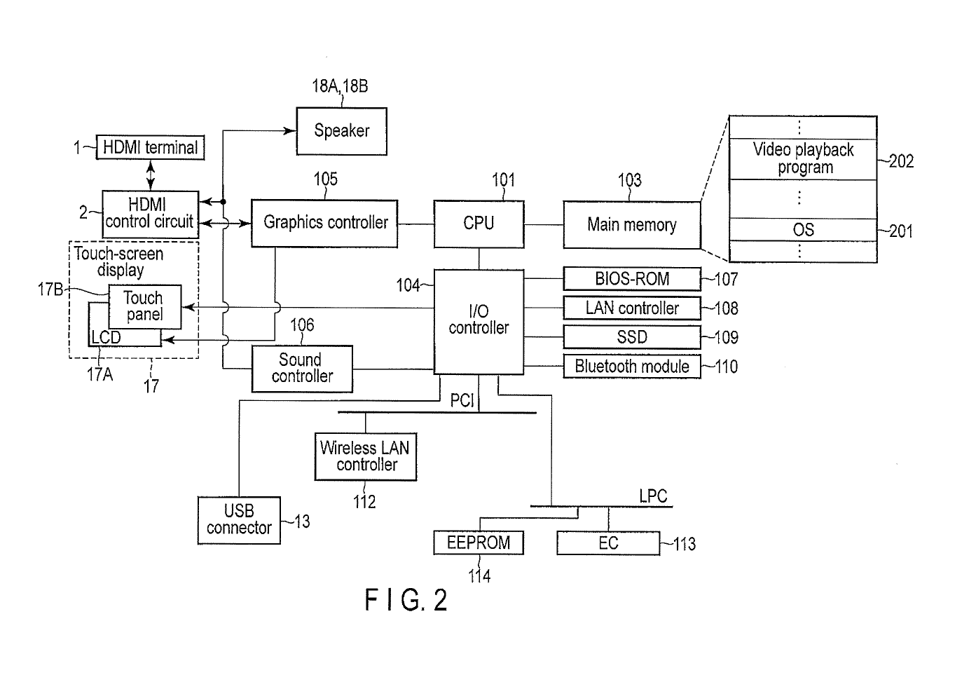

FIG. 2 shows the system configuration of the computer 10.

The computer 10, as shown in FIG. 2, includes a CPU 101, a main memory 103, an I/O controller 104, a graphics controller 105, a sound controller 106, a BIOS-ROM 107, a LAN controller 108, a solid-state driver (SSD) 109, a Bluetooth® module 110, a wireless LAN controller 112, an embedded controller (EC) 113, an EEPROM 114, and an HDMI control circuit 2.

The CPU 101 is a processor for controlling the operation of the respective components of the computer 10. The CPU 101 executes an operating system (OS) 201, a video playback program 202 and various application programs, which are loaded from the SSD 109 into the main memory 103. The video playback program 202 includes a video playback (playback) function for displaying a video on the display 17 by playing video data. The video playback program 202 plays designated video data, for example, in accordance with an operation by the user. The video data is, for example, data stored in a storage device such as the SSD 109. The video data may be data which is received via a network. In addition, the video data may be data stored in external storage media such as a USB flash memory or an SD card. The video playback program 202 decodes video data which is encoded (compression-encoded), thereby playing the video data.

The video playback program 202 also has a flicker reduction function for reducing (correcting) flicker occurring in a played back video. For example, the video playback program 202 adds, with a predetermined weighting factor, a pixel included in an image frame of a processing target and a pixel which corresponds to this pixel and is included in a frame immediately preceding the image frame of the processing target (hereinafter also referred to as “immediately preceding frame”), and setting the added value for a first pixel, thereby reducing flicker occurring in the processing-target image frame.

In general, in the tablet-type computer 10, the distance (viewing distance) between the user and the display 17 is shorter than in ordinary notebook-type or desktop-type computers, and the angle at which the user views the display 17 varies more easily. In addition, in some cases, in the tablet-type computer 10, the response speed of liquid crystal that is used in the display 17 is lower. Consequently, noise such as flicker tends to affect the viewing of a video by the user. The video playback program 202 displays a video which the user can comfortably view, even in the case of the structure which is easily affected by noise such as flicker, as in the case of the table-type computer 10.

In addition, since the video playback program 202 requires an operation using a plurality of frames or an operation using many pixels in the frame, it is possible that the amount of operations becomes large. These operations are realized, for example, by using instructions (commands) for such parallel operations as to enable, not the execution of an operation on a pixel-by-pixel basis, but the simultaneous execution of operations of a plurality of pixels (e.g. eight pixels). Thus, commands for parallel operations may be stored in the computer 10.

Besides, the CPU 101 executes a BIOS that is stored in the BIOS-ROM 107. The BIOS is a program for hardware control. The CPU 101 includes a memory controller which access-controls the main memory 103. The CPU 101 also has a function of communicating with the graphics controller 105 via, e.g. a PCI EXPRESS serial bus.

The graphics controller 105 is a display controller which controls the LCD 17A that is used as a display monitor of the computer 10. A display signal, which is generated by the graphics controller 105, is sent to the LCD 17A. The LCD 17A displays video, based on the display signal.

The HDMI terminal 1 is the above-described external display connection terminal. The HDMI terminal 1 is capable of sending a non-compressed digital video signal and digital audio signal to an external display device via a single cable. The HDMI control circuit 2 is an interface for sending a digital video signal to the external display device, which is called “HDMI monitor”, via the HDMI terminal 1.

The I/O controller 104 is connected to the CPU 101, and controls devices on a Peripheral Component Interconnect (PCI) bus and devices on a Low Pin Count (LPC) bus. The I/O controller 104 includes an integrated drive electronics (IDE) controller for controlling the SSD 109.

The I/O controller 104 includes a USB controller for controlling the touch panel 17B. The touch panel 17B is a pointing device for executing an input on the screen of the LCD 17A. The user can operate a graphical user interface (GUI), or the like, which is displayed on the screen of the LCD 17A, by using the touch panel 17B. For example, by touching a button displayed on the screen, the user can instruct execution of a function associated with the button. In addition, the USB controller communicates with an external device, for example, via a cable of the USB 2.0 standard which is connected to the USB connector 13.

The I/O controller 104 also has a function of communicating with the sound controller 106. The sound controller 106 is a sound source device and outputs audio data, which is a target of playback (reproduction), to the speakers 18A and 18B. The LAN controller 108 is a wired communication device which executes wired communication of, e.g. the IEEE 802.3 standard. The wireless LAN controller 112 is a wireless communication device which executes wireless communication of, e.g. the IEEE 802.11g standard. The Bluetooth module 110 is a communication module which executes Bluetooth communication with an external device.

The EC 113 is a one-chip microcomputer including an embedded controller for power management. The EC 113 has a function of powering on/off the computer 10 in accordance with the user's operation of the power button.

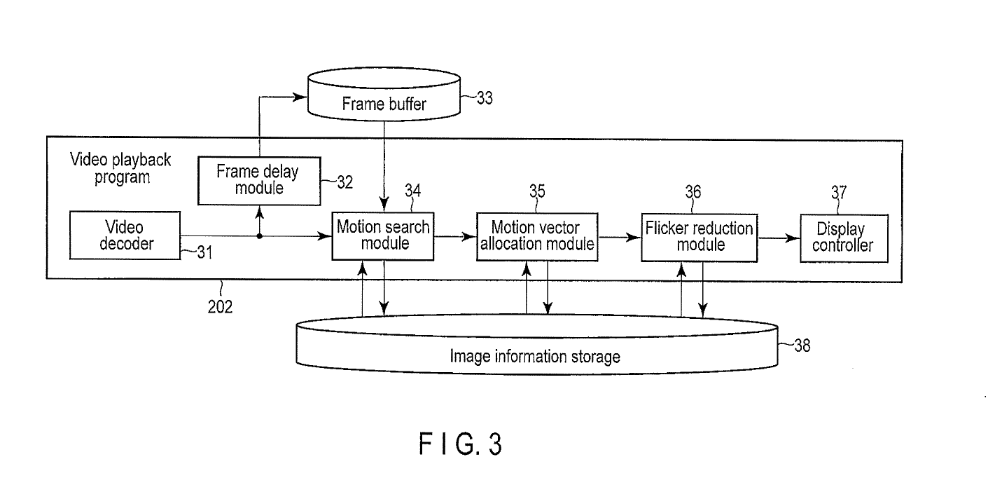

Next, referring to FIG. 3, a functional configuration of the video playback program 202 is described. The video playback program 202, as described above, includes the video playback function for playing video data, and the flicker reduction function for reducing flicker occurring in the played back video.

In the flicker reduction function, flicker is reduced, for example, by blending pixel values between an input image frame (also referred to as “processing-target frame”) and a reference image frame (also referred to as “immediately preceding frame of the processing-target frame”). A pixel X in the input image frame and a pixel Y in the reference image frame, which corresponds to the pixel X, are blended, for example, by using a weighting factor W. The weighting factor W is calculated, for example, based on a linear function or a non-linear function. Accordingly, a pixel X_{B}, which is newly set by the blending, is calculated by, e.g. the following equation:

X_{B}=WX−(1−W)Y.

The weighting factor W needs to be varied, for example, in accordance with a difference (e.g. |X−Y|) between the input image frame and reference image frame. The reason for this is that in an area with a large difference between frames, an edge blurs or an error propagation, such as afterimage, which occurs in the vicinity of a moving object, due to the blending of pixel values. By varying the weighting factor, based on the difference between the frames, the image quality of the input image frame can be adjusted so that flicker may decrease and pixels of an edge part may not blur.

However, a variation (difference signal) between the reference image frame and input image frame occurs, not only due to flicker but also due to a moving object captured in the video. It is thus difficult to determine, based on the difference signal, whether the variation of the input image frame, relative to the reference image frame, occurs due to flicker or a moving object. In addition, as regards a still object (including a background), it is highly possible that the position of the still object on the reference image frame is the same as the position of the still object on the input image frame. However, since the moving object moves, for example, from the reference image frame to the input image frame, it is possible that the position of the moving object on the reference image frame differs from the position of the moving object on the input image frame. Thus, when pixels at the same position between the reference image frame and input image frame are blended, for example, a pixel on the background and a pixel on a moving object are blended, so the flicker occurring in the image cannot properly be reduced. In addition, since an error occurring due to the blending propagates to a subsequent frame (i.e. since a frame including a pixel, to which blending has been applied, is used in a flicker reduction process of a subsequent frame), it is possible that an image in which flicker is properly reduced cannot be displayed in the subsequent frame.

Thus, the video playback program 202 executes a flicker reduction process on the processing-target frame, taking into account a motion between the processing-target frame and the immediately preceding frame. To be more specific, a motion vector corresponding to the processing-target frame is determined, and a first pixel in the processing-target frame and a second pixel in the immediately preceding frame, which corresponds to the first pixel, are determined, based on the determined motion vector. By blending the first pixel and the second pixel, flicker occurring in the processing-target frame is reduced.

The video playback program 202 includes a video decoder 31, a frame delay module 32, a motion search module 34, a motion vector allocation module 35, a flicker reduction module 36, and a display controller 37.

The video decoder 31 decodes video data, thereby generating decoded video data. The video data is, for example, compression-encoded data. The video decoder 31 decodes video data, for example, responding to the fact that playback of video data has been instructed by the user, the fact that video data has been received via a network, or the fact that a storage medium, such as a USB flash memory or an SD card, which includes video data, has been detected.

The decoded video data includes a plurality of image frames (hereinafter also referred to as “frames”). The video decoder 31 sets a plurality of image frames, one by one from the first image frame, to be a processing-target frame T. Then, the video decoder 31 outputs the set processing-target frame T to the frame delay module 32 and motion search module 34.

The frame delay module 32 stores (buffers) the processing-target frame T in a frame buffer 33, thereby outputting a frame (T−1), which immediately precedes the processing-target frame T, to the motion search module 34.

Using the immediately preceding frame (T−1) output by the frame delay module 32 and the processing-target frame T output by the video decoder 31, the motion search module 34 calculates a motion vector of each of pixel blocks of an intermediate frame (T−0.5) between the immediately preceding frame (T−1) and the processing-target frame T. The motion search module 34 calculates a motion vector of each of pixel blocks of the intermediate frame (T−0.5), for example, by estimating a motion between the intermediate frame (T−0.5) and the processing-target frame T. The pixel block is, for example, a block of 4×4 pixels. For example, a motion vector, which has already been calculated by a frame interpolation process for generating an interpolation frame, may be used for the motion vector of each pixel block of the intermediate frame (T−0.5). The motion search module 34 outputs the calculated motion vector of each pixel block of the intermediate frame (T−0.5) to the motion vector allocation module 35. In addition, the motion search block 34 stores, in an image information storage 38, information indicative of the calculated motion vector of each pixel block of the intermediate frame (T−0.5), information indicative of the processing-target frame T, and information indicative of the immediately preceding frame (T−1). The image information storage 38 is a storage area for storing various kinds of information which is used when video data is played back.

The motion vector allocation module 35 determines a plurality of motion vectors which are allocated to a plurality of pixel blocks in the processing-target frame T, by using the motion vector of each pixel block of the intermediate frame (T−0.5) output by the motion search module 34. Based on the determined motion vectors, the motion vector allocation module 35 determines a plurality of pixel blocks in the processing-target frame T, and pixel blocks in the immediately preceding frame (T−1), which correspond to the plurality of pixel blocks in the processing-target frame T.

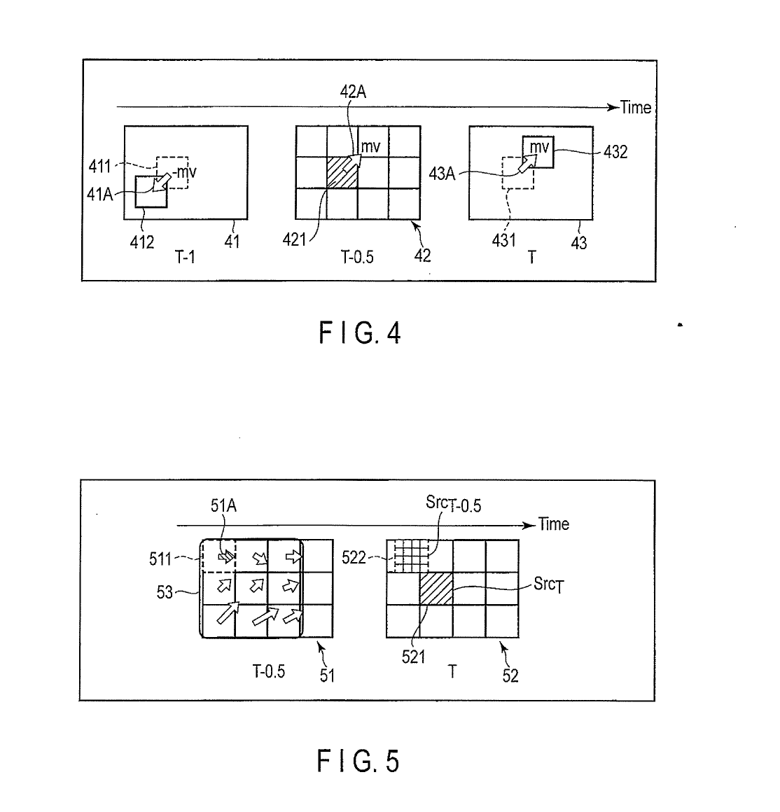

A symmetric search, for instance, may be used as the method of searching a plurality of motion vectors which are allocated to a plurality of pixel blocks in the processing-target frame T, by using the motion vector of each pixel block of the intermediate frame (T−0.5). FIG. 4 illustrates an example in which the motion of a processing-target pixel block is searched by the symmetric search. In the symmetric search, a search for a motion is performed, centering on an intermediate frame 42 between a processing-target frame 43 and an immediately preceding frame 41. In the example illustrated in FIG. 4, it is assumed that a motion vector of each pixel block of the intermediate frame 42 is determined. The motion vector of each pixel block of the intermediate frame 42 is a vector indicative of the motion from the intermediate frame 42 to the processing-target frame 43.

For example, with respect to a pixel block 421 in the intermediate frame 42, a pixel block 432 in the processing-target frame 43, which corresponds to the pixel block 421, is detected based on a motion vector 42A (mv) corresponding to the pixel block 421. The pixel block 432 is a block corresponding to an area to which the pixel block 421 is moved in accordance with the motion vector 42A. In addition, a pixel block 412 in the immediately preceding frame 41, which corresponds to the pixel block 421, is detected based on a motion vector 41A (−mv) which is symmetric to the motion vector 42A. The pixel block 412 is a block corresponding to an area to which the pixel block 421 is moved in accordance with the motion vector 41A. Based on these, in the symmetric search, it is determined that the pixel block 432 in the processing-target frame 43 and the pixel block 412 in the immediately preceding frame correspond to each other.

However, since the search for the motion is performed centering on the intermediate frame 42, it is possible that a pixel, which is not included in the area to which the pixel block in the intermediate frame 42 moves based on the motion vector, is present in the pixels in the processing-target frame 43. In other words, it is possible that a pixel in the intermediate frame 42, which corresponds to a pixel in the processing-target frame 43, is not determined. Similarly, it is possible that a pixel in the intermediate frame 42, which corresponds to a pixel in the immediately preceding frame 41, is not determined. In this case, the correspondence between a pixel in the processing-target frame 43 and a pixel in the immediately preceding frame 41 cannot be determined. In short, a missing area (i.e. an area where motion information cannot be referred to), which fails to correspond to a pixel in the immediately preceding frame 41, would be present in the processing-target frame 43.

Thus, in the symmetric search, for example, a zero vector is used as a motion vector which corresponds to a pixel included in the missing area. Thereby, a pixel in the immediately preceding frame 41, which corresponds to the pixel included in the missing area, is determined. Specifically, as regards the pixel included in the missing area, the pixels at the same position between the processing-target frame 43 and the immediately preceding frame 41 are associated. In addition, for example, as a motion vector corresponding to a pixel included in the missing area, use is made of a motion vector corresponding to a pixel near the pixel included in the missing area. Thereby, a pixel in the immediately preceding frame 41, which corresponds to the pixel included in the missing area, is determined. However, in the case of the pixels determined by this method, it is possible that pixels, which are not based on the motion between the processing-target frame 43 and immediately preceding frame 41, are associated. Consequently, when blending for reducing flicker is performed by using such pixels, it is possible that a discontinuous area, such as a boundary area, occurs in the processing-target frame. Hence, there is a concern that the user may feel unnaturalness of a displayed video.

Taking the above into account, in the present embodiment, a plurality of motion vectors (first motion vectors) corresponding to a plurality of pixel blocks in the processing-target frame T are determined by using a plurality of motion vectors (second motion vectors) corresponding to a plurality of pixel blocks in the intermediate frame (T−0.5). Thereby, pixel blocks in the immediately preceding frame (T−1), which correspond to the plurality of pixel blocks in the processing-target frame T, are determined.

To be more specific, the motion vector allocation module 35 first divides the processing-target frame T into pixel blocks of a predetermined size. The pixel block is, for example, a block of 4×4 pixels, as described above. Subsequently, the motion vector allocation module 35 sets a processing-target pixel block among the pixel blocks in the processing-target frame T. For example, the motion vector allocation module 35 successively sets a pixel block of the pixel blocks in the processing-target frame T, from the pixel block at the upper left end, to be the processing-target pixel block.

Subsequently, the motion vector allocation module 35 pays attention to, among the pixel blocks set in the intermediate frame (T−0.5), a pixel block at the position corresponding to the processing-target pixel block, and pixel blocks neighboring that pixel block. For example, the motion vector allocation module 35 sets, among the pixel blocks set in the intermediate frame (T−0.5), 3×3 pixel blocks (nine pixel blocks) centering on the pixel block at the position corresponding to the processing-target pixel block, to be pixel blocks of interest. Then, the motion vector allocation module 35 sets motion vectors, which correspond to the pixel blocks of interest, to be candidate motion vectors. For example, when 3×3 pixel blocks are set to be pixel blocks of interest, the motion vector allocation module 35 sets nine motion vectors, which correspond to the 3×3 pixel blocks of interest, to be candidate motion vectors.

Then, the motion vector allocation module 35 selects a motion vector, which most refers to the processing-target pixel block, from among the motion vectors of the respective pixel blocks of the intermediate frame (T−0.5). Specifically, the motion vector allocation module 35 calculates evaluation values f(x) of the set candidate vectors by the following equation:

$$f ( x ) = \sum \{ \begin{matrix}1 & if {Src}_{T - 0.5} ( i + mvx , j + mvy ) ∈ {Src}_{T} \\ 0 & else\end{matrix}$$

where Src_{T-0.5} (i,j) is indicative of a pixel corresponding to a position indicated by (i,j), among a plurality of pixels included in a pixel block of interest; Src_{T} is indicative of all pixels included in the processing-target pixel block; my is a motion vector corresponding to the pixel block of interest; mvx is a horizontal component of the motion vector mv; and mvy is a vertical component of the motion vector mv. Accordingly, when the pixel block of interest has been moved based on the motion vector mv, the calculated evaluation value f(x) indicates the size of an overlapping area between the pixel Src_{T-0.5} (i+mvx, j+mvy) of the moved pixel block of interest and the pixel Src_{T} of the processing target pixel block. This size is expressed by, e.g. the number of pixels. In the meantime, the motion vector allocation module 35 may weight the calculated evaluation values f(x). For example, the motion vector allocation module 35 weights the calculated evaluation value f(x) with such a weight as to become greater with respect to a pixel block of interest which is closer to the processing-target pixel block, and uses the resultant value as the evaluation value f(x).

Subsequently, the motion vector allocation module 35 sets a motion vector with the highest evaluation value f(x), among the candidate vectors, to be a motion vector MV of the processing-target pixel block, as indicated by the following equation:

MV=max f(x).

Based on the determined motion vector of the processing-target pixel block, the motion vector allocation module 35 determines the pixel block in the immediately preceding frame (T−1) which corresponds to the processing-target pixel block. Specifically, the motion vector allocation module 35 determines the pixel block, which is at a position indicated based on the determined motion vector, to be the pixel block in the immediately preceding frame (T−1) which corresponds to the processing-target pixel block. By using the motion vector, the motion between the frames is taken into account. Thus, even when a processing-target pixel block is included in a moving object, the pixel block in the processing-target frame T and the pixel block in the immediately preceding frame (T−1) can correctly be associated.

By repeating the above-described procedure, the motion vector allocation module 35 determines the pixel blocks in the immediately preceding frame (T−1), which correspond to the plural pixel blocks in the processing-target frame T. The motion vector allocation module 35 outputs to the flicker reduction module 36 the information indicating the plural pixel blocks in the processing-target frame T and the pixel blocks in the immediately preceding frame (T−1), which correspond to the plural pixel blocks in the processing-target frame T. In addition, the motion vector allocation module 35 stores this information in the image information storage 38. Examples of the search for the motion of the processing-target pixel block will be described later with reference to FIGS. 5, 6 and 7.

The flicker reduction module 36 reduces flicker occurring when the processing-target frame T is played back (displayed), by using the information which has been output by the motion vector allocation module 35 and is indicative of the plural pixel blocks in the processing-target frame T and the pixel blocks in the immediately preceding frame (T−1), which correspond to the plural pixel blocks in the processing-target frame T. Using the information output by the motion vector allocation module 35, the flicker reduction module 36 blends the pixels included in the pixel block in the processing-target frame T and the pixels included in the corresponding pixel block in the immediately preceding frame (T−1). In short, the flicker reduction module 36 blends the corresponding pixels, based on the motion vector.

To be more specific, the flicker reduction module 36 sets a processing-target pixel block among a plurality of pixel blocks set in the processing-target frame T. Then, based on the information output by the motion vector allocation module 35, the flicker reduction module 36 determines the corresponding pixel block in the immediately preceding image frame (T−1).

Subsequently, the flicker reduction module 36 sets values, which are obtained by blending a first pixel in the processing-target pixel block and a second pixel in the determined pixel block, which correspond to the first pixel, in the first pixel. For example, when the pixel block is a block of 4×4 pixels, the flicker reduction module 36 blends 16 pixels in the processing-target pixel block and 16 pixels in the determined pixel block respectively, each of the 16 pixels in the processing-target pixel block corresponding in position to each of the 16 pixels in the determined pixel block. This blending is, for example, a weighted addition of pixel values. The weighting factor W, which is used for the weighting, is, for example, a predetermined value, or a value which is determined based on an inter-frame difference between the processing-target frame T and the immediately preceding frame (T−1).

The flicker reduction module 36 applies the blending to all pixel blocks (pixels) set in the processing-target frame T. By the blending, flicker occurring when the processing-target frame T is played back can be reduced. The flicker reduction module 36 outputs the processing-target frame T, in which flicker has been reduced, to the display controller 37.

The display controller 37 displays on the screen (LCD 17A) the processing-target frame output by the flicker reduction module 36. Specifically, the display controller 37 successively displays processing-target image frames in which flicker has been reduced.

By the above-described structure, flicker, which occurs when a video including a moving object is played back, can be reduced. The motion vector allocation module 35 determines a motion vector of each pixel block of the processing-target frame T, by using a motion vector of each pixel block of the intermediate frame (T−0.5). In addition, the motion vector allocation module 35 determines the pixel block in the processing-target frame T and the pixel block in the immediately preceding frame (T−01) which corresponds to the pixel block in the processing-target frame T, with the motion between the frames being taken into account by using the determined motion vector. Thereby, the flicker reduction module 36 can reduce flicker occurring when the processing-target frame T is played back, by using the two corresponding pixel blocks, with respect to which the motion between the frames has been taken into account.

FIGS. 5, 6 and 7 illustrate examples in which a motion vector is allocated to a processing-target pixel block 521 by the motion vector allocation module 35. In the description below, it is assumed that the pixel block 521, among a plurality of pixel blocks in a processing-target frame 52, is set to be a processing-target pixel block. The motion vector allocation module 35 selects a motion vector, which is most suited to the processing-target pixel block 521, from among motion vectors 53 which are included in the motion vectors of the respective pixel blocks of an intermediate frame 51 and are near a position corresponding to the processing-target pixel block 521. Specifically, the motion vector allocation module 35 calculates an evaluation value f(x) which is indicative of a degree of how much each of the motion vectors in the motion vectors 53 is suited to the motion vector of the processing-target pixel block 521.

For example, referring to FIG. 5, a description is given of an example in which an evaluation value of a motion vector 51A, which corresponds to a pixel block 511, is calculated. The motion vector 51A indicates that the pixel block 511 in the intermediate frame 51 moves to an area indicated by a pixel block 522 in the processing-target image frame 52. In other words, the motion vector 51A indicates that the pixel block 511 and pixel block 522 correspond to each other. Since the number of pixels overlapping between the pixel block 522 and the processing-target pixel block 521 is calculated as an evaluation value of the motion vector 51A, the evaluation value of the motion vector 51A is 0.

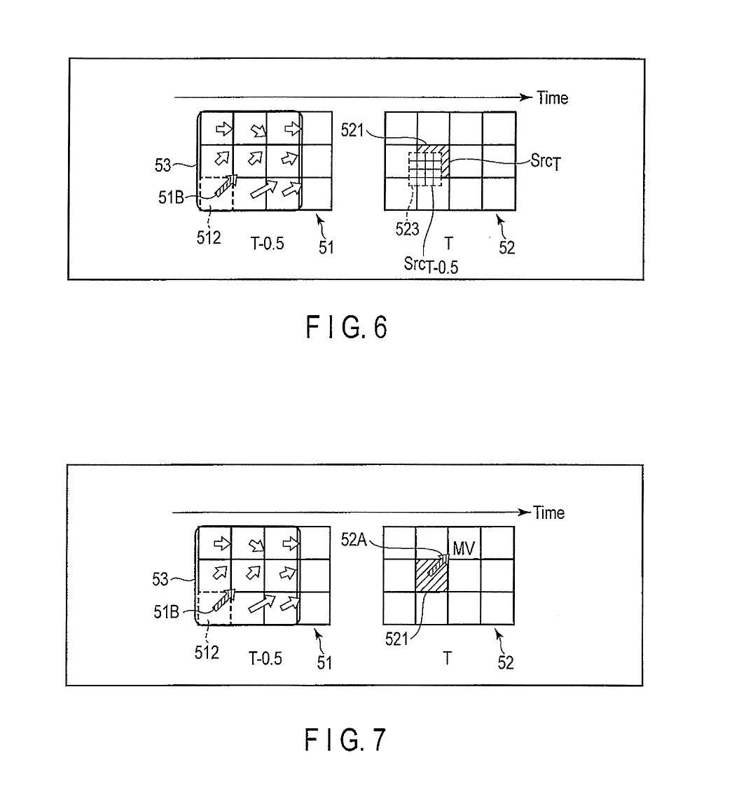

Referring to FIG. 6, a description is given of an example in which an evaluation value of a motion vector 51B, which corresponds to a pixel block 512, is calculated. The motion vector 51B indicates that the pixel block 512 in the intermediate frame 51 moves to a position indicated by a pixel block 523 in the processing-target image frame 52. In other words, the motion vector 51B indicates that the pixel block 512 and pixel block 523 correspond to each other. Since the number of pixels overlapping between the pixel block 523 and the processing-target pixel block 521 is calculated as an evaluation value of the motion vector 51B, the evaluation value of the motion vector 51B is 9.

Similarly, the evaluation values of all motion vectors included in the motion vectors 53 are calculated. Then, as illustrated in FIG. 7, the motion vector 51B having the highest calculated evaluation value is determined to be a motion vector (MV) 52A of the processing-target pixel block 521.

As has been described above, of the motion vectors of the respective pixel blocks of the intermediate frame 51, the motion vector, which is most suited to the processing-target pixel block 521, is set to be the motion vector 52A of the processing-target pixel block 521. By executing the above-described process with respect to all pixel blocks in the processing-target frame 52, the motion vectors corresponding to all pixel blocks are determined. Thereby, without a missing area occurring as in the case of the symmetric search, it is possible to determine corresponding pixel blocks in the immediately preceding frame with respect to all pixel blocks in the processing-target frame. In addition, when a frame interpolation process, or a noise reduction process within a frame (in a spatial direction), which makes use of a motion, is executed on video data, the motion vectors of the respective pixel blocks of an interpolation frame, which has already been calculated in the frame interpolation process or the noise reduction process, can be used in determining the motion vectors of the respective pixel blocks in the processing-target frame. Therefore, the cost for calculations can be reduced, compared to the case of calculating the motion vectors of the respective pixel blocks in the processing-target frame by using the processing-target frame T and the immediately preceding frame (T−1).

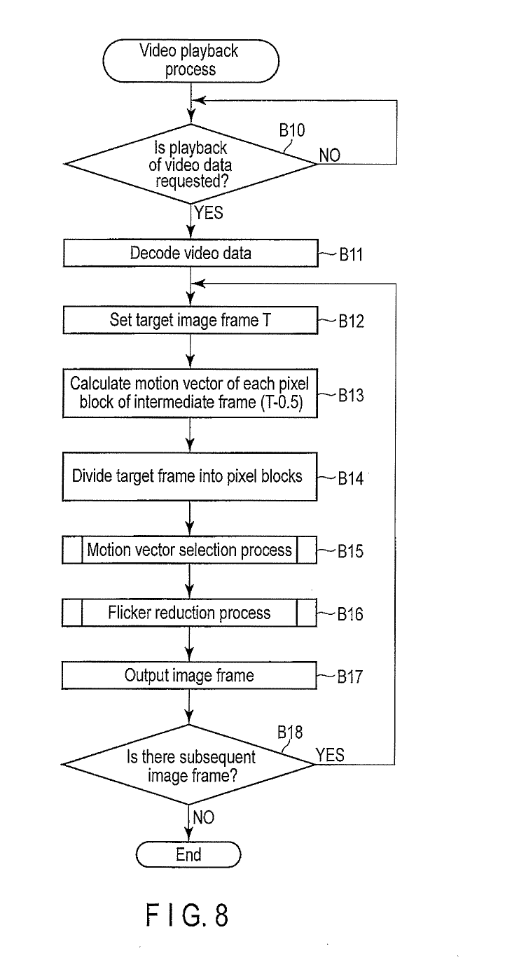

Next, referring to FIG. 8, a description is given of an example the procedure of a video playback process which is executed by the computer 10.

To start with, the video decoder 31 determines whether playback of video data has been requested (block B10). The video data is, for example, compression-encoded data. When playback of video data has not been requested (NO in block B10), the video decoder 31 returns to block B10, and determines once again whether playback of video data has been requested.

When playback of video data has been requested (YES in block B10), the video decoder 31 decodes video data (block B11). The video decoder 31 sets one of a plurality of image frames, which are included in the decoded video data, to be a processing-target frame T (block B12). Since the processing-target frame T and an immediately preceding frame (T−1) are used in the process for reducing flicker occurring in the frame, the video decoder 31 sets, for example, a plurality of image frames, one by one from the second frame, to be the processing-target frame T. In this case, the display controller 37 controls displaying the first frame without change on the screen 17.

Then, the motion search module 34 calculates a motion vector of each of pixel blocks of an intermediate frame (T−0.5) between the processing-target frame T and the immediately preceding frame (T−1) (block B13). Specifically, the motion search module 34 estimates a motion between the intermediate frame (T−0.5) and the processing-target frame T. The pixel block is, for example, a block of 4×4 pixels. Besides, a motion vector, which has already been calculated for generating the intermediate frame (T−0.5), may be used for the motion vector of each pixel block of the intermediate frame (T−0.5).

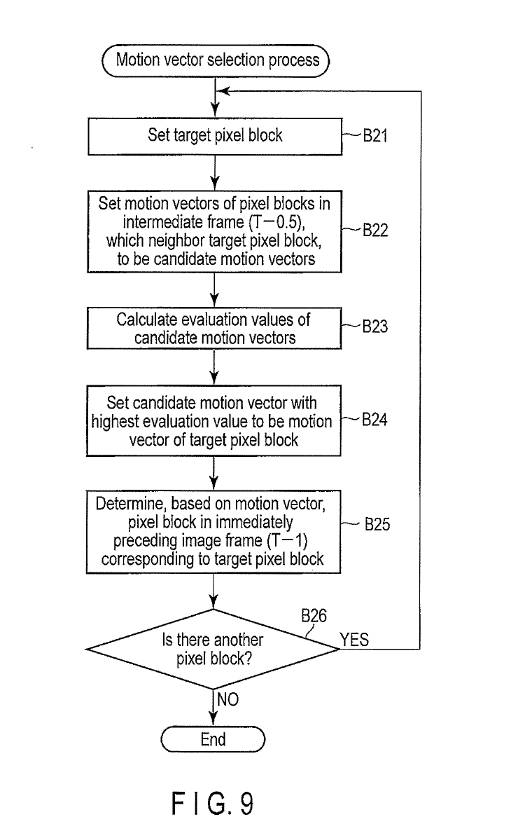

The motion vector allocation module 35 divides the processing-target frame T into a plurality of pixel blocks (block B14). The pixel block is, for example, a block of 4×4 pixels, as described above. Then, the motion vector allocation module 35 executes a motion vector selection process for determining a motion vector of each pixel block of the processing-target frame T, by using the motion vector of each pixel block of the intermediate frame (T−0.5) (block B15). The procedure of the motion vector selection process will be described later with reference to a flowchart of FIG. 9.

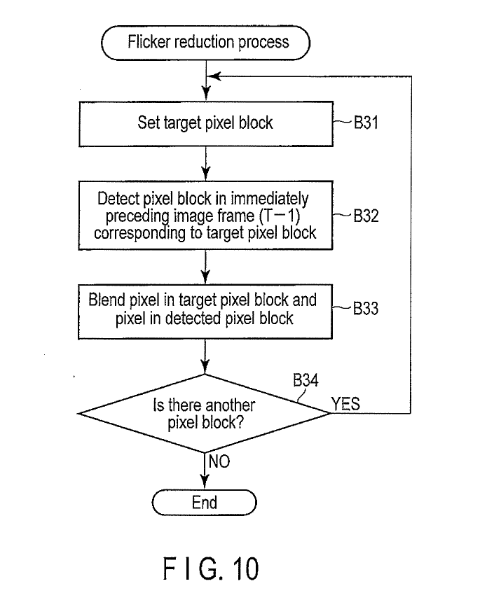

Then, the flicker reduction module 36 executes, based on the motion vector of each pixel block of the processing-target frame T, a flicker reduction process for reducing flicker occurring in the processing-target frame T, by using the processing-target frame T and the immediately preceding frame (T−1) (block B16). The procedure of the flicker reduction process will be described later with reference to a flowchart of FIG. 10.

Following the above, the display controller 37 controls displaying the processing-target frame, which has been subjected to the flicker reduction process, on the screen 17 (block B17). Then, the video decoder 31 determines whether there is a subsequent image frame which follows the present processing-target frame T (block B18). When there is a subsequent image frame (YES in block B18), the process returns to block B12, and the subsequent image frame is set to be a new processing-target frame T. Thus, the above-described process is executed on the new processing-target frame T.

When there is no subsequent image frame (NO in block B18), that is, when all image frames of the video data have been displayed on the screen 17, the video playback process is completed.

In the meantime, the motion vector selection process and the flicker reduction process may be executed on the first frame of the video data. In this case, for example, the motion vector of each pixel block of the first frame is determined by using the motion vector of each pixel block of an intermediate frame between the first frame and the second frame, and the flicker occurring in the first frame is reduced by using the first frame and the second frame. In addition, when the motion vector is calculated in block B13, the motion search module 34 may detect whether a scene change occurs between the processing-target frame T and the immediately preceding frame (T−1). When a scene change occurs between the processing-target frame T and the immediately preceding frame (T−1), the flicker reduction process is not executed on the processing-target frame. The reason for this is that no flicker occurs when a frame corresponding to a scene change is played back, and the occurrence of unnecessary error propagation, which would occur if the flicker reduction process was executed on such a frame, is prevented.

Next, referring to FIG. 9, a description is given of an example of the procedure of the motion vector selection process for determining the motion vector of each pixel block of the processing-target frame T.

To start with, the motion vector allocation module 35 sets a processing-target pixel block among a plurality of pixel blocks in the processing-target frame T (block B21). Specifically, the motion vector allocation module 35 successively sets the pixel blocks in the processing-target frame T, for example, from the pixel block at the upper left end, to be the processing-target pixel block.

Subsequently, the motion vector allocation module 35 pays attention to, among the pixel blocks set in the intermediate frame (T−0.5), a pixel block at the position corresponding to the processing-target pixel block, and pixel blocks neighboring that pixel block, and sets the motion vectors of these pixel blocks of interest to be candidate motion vectors (block B22). For example, the motion vector allocation module 35 sets, among the pixel blocks set in the intermediate frame (T−0.5), the motion vectors of 3×3 pixel blocks, which center on the pixel block at the position corresponding to the processing-target pixel block, to be candidate motion vectors.

Then, the motion vector allocation module 35 calculates evaluation values of the set candidate motion vectors (block B23). As has been described with reference to FIGS. 5 and 6, the evaluation value of the candidate motion vector indicates, for example, the number of pixels overlapping between the pixel block indicated by the candidate motion vector and the processing-target pixel block. Based on the calculated evaluation values of the respective candidate motion vectors, the motion vector allocation module 35 selects a candidate motion vector having the highest evaluation value, thereby determining the motion vector of the processing-target pixel block (block B24).

Subsequently, based on the determined motion vector, the motion vector allocation module 35 determines the pixel block in the immediately preceding image frame (T−1), which corresponds to the processing-target pixel block (block B25). In short, taking into account the motion between the processing-target image frame T and the immediately preceding image frame (T−1), the motion vector allocation module 35 determines the pixel block in the immediately preceding image frame (T−1), which corresponds to the processing-target pixel block.

Then, the motion vector allocation module 35 determines whether there is a pixel block with respect to which the corresponding pixel block in the immediately preceding image frame (T−1) has not been determined (block B26). When there is a pixel block with respect to which the corresponding pixel block in the immediately preceding image frame (T−1) has not been determined (YES in block B26), the motion vector allocation module 35 returns to block B21, sets a new processing-target pixel block, and determines a pixel block in the immediately preceding image frame (T−1), which corresponds to the new processing-target pixel block. When there is no pixel block with respect to which the corresponding pixel block in the immediately preceding image frame (T−1) has not been determined (NO in block B26), that is, when the pixel blocks in the immediately preceding image frame (T−1), which correspond to all pixel blocks, have been determined, the motion vector selection process is completed.

A flowchart of FIG. 10 illustrates an example of the procedure of the flicker reduction process for reducing flicker occurring in the processing-target frame T.

To start with, the flicker reduction module 36 sets a processing-target pixel block among a plurality of pixel blocks which are set in the processing-target frame T (block B31). Then, the flicker reduction module 36 detects a pixel block in the immediately preceding image frame (T−1), which corresponds to the set processing-target pixel block (block B32).

Subsequently, the flicker reduction module 36 blends the pixel in the processing-target pixel block and the corresponding pixel in the detected pixel block (block B33). For example, when the pixel block is a block of 4×4 pixels, the flicker reduction module 36 blends 16 pixels in the processing-target pixel block and 16 pixels in the determined pixel block respectively, each of the 16 pixels in the processing-target pixel block corresponding in position to each of the 16 pixels in the determined pixel block. This blending is, for example, a weighted addition of pixel values. The value, which is used for the weighting, is, for example, a predetermined value, or a value which is determined based on a difference. By the blending, the flicker occurring in the processing-target pixel block can be reduced.

Then, the flicker reduction module 36 determines whether there is a pixel block to which the blending has not been applied (block B34). When there is a pixel block to which the blending has not been applied (YES in block B34), the flicker reduction module 36 returns to block B31, and sets a new processing-target pixel block, thereby applying the blending to this pixel block. When there is no pixel block to which the blending has not been applied (NO in block B34), the flicker reduction process is completed.

As has been described above, according to the present embodiment, flicker, which occurs when a video including a moving object is played back, can be reduced. The motion vector allocation module 35 determines a motion vector of each pixel block of the processing-target frame T, by using a motion vector of each pixel block of the intermediate frame (T−0.5). Then, taking into account the motion between the frames by using the determined motion vector, the motion vector allocation module 35 determines the pixel block in the processing-target frame T and the pixel block in the immediately preceding frame (T−1) which corresponds to the pixel block in the processing-target frame T. Specifically, by using the motion vector, the moving object (the pixel block corresponding to the moving object), which moves between the frames, can be traced. Thus, the flicker reduction module 36 can reduce flicker occurring when the processing-target frame T is played back (displayed), by using the two pixel blocks, with respect to which the motion between the frames has been traced.

All the procedures of the video playback process according to this embodiment can be executed by software. Thus, the same advantageous effects as with the present embodiment can easily be obtained simply by installing a computer program, which executes the procedures of the video playback process, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a motion search module configured to determine first vectors comprising a plurality of motion vectors corresponding to a plurality of pixel blocks in a target frame in video data, and to determine a plurality of pixels in a previous frame by using the determined first vectors, the previous frame immediately preceding the target frame, the plurality of pixels corresponding to a plurality of pixels in the target frame;
a flicker reduction module configured to reduce flicker occurring when the target frame is played back, by blending a first pixel in the target frame and a second pixel in the previous frame, the second pixel corresponding to the first pixel; and
a display controller configured to control displaying the target frame comprising the blended pixel on a screen.

2. The electronic apparatus of claim 1, wherein the motion search module is configured to determine the first vectors by using second vectors comprising a plurality of motion vectors which correspond to a plurality of pixel blocks in an intermediate frame between the target frame and the previous frame.

3. The electronic apparatus of claim 2, wherein the motion search module is configured to calculate, with respect to one or more pixel blocks of the plurality of pixel blocks in the intermediate frame, an evaluation value indicative of a size of an overlapping area between a first pixel block of the plurality of pixel blocks in the target frame and an area to which a second pixel block of the one or more pixel blocks is moved based on a motion vector corresponding to the second pixel, and to set a motion vector, which corresponds to the second pixel block with a highest evaluation value that is calculated, to be a motion vector corresponding to the first pixel block.

4. The electronic apparatus of claim 3, wherein the one or more pixel blocks comprise, among the plurality of pixel blocks in the intermediate frame, a pixel block at a position corresponding to the first pixel block and a pixel block at a position corresponding to a pixel block near the first pixel block.

5. The electronic apparatus of claim 2, wherein the motion search module is configured to set one of the plurality of motion vectors in the second vectors to be each of the plurality of motion vectors in the first vectors.

6. The electronic apparatus of claim 1, wherein the flicker reduction module is configured to reduce the flicker by adding the first pixel in the target frame and the second pixel in the previous frame with use of a predetermined weighting factor, and setting a value for the first pixel in the target frame, the value being obtained by the addition.

7. An image processing method comprising:
determining first vectors comprising a plurality of motion vectors corresponding to a plurality of pixel blocks in a target frame in video data, and determining a plurality of pixels in a previous frame by using the determined first vectors, the previous frame immediately preceding the target frame, the plurality of pixels corresponding to a plurality of pixels in the target frame;
reducing flicker occurring when the target frame is played back, by blending a first pixel in the target frame and a second pixel in the previous frame, the second pixel corresponding to the first pixel; and
controlling displaying the target frame comprising the blended pixel on a screen.
